(19) United States
(12) Patent Application Publication
(10) Pub. No.: US 2022/0394144 A1
(43) Pub. Date: Dec. 8, 2022

(54) HINGE SUPPORT ASSEMBLIES TO PREVENT LATERAL MOVEMENT OF LIDS RELATIVE TO HINGES

(71) Applicant: Hewlett-Packard Development Company, L.P., Spring, TX (US)

(72) Inventors: Jotham Cheng Xin CHANG, Singapore (SG); U Kyaw Thu RA, Singapore (SG)

(73) Assignee: Hewlett-Packard Development Company, L.P., Spring, TX (US)

(21) Appl. No.: 17/337,244

(22) Filed: Jun. 2, 2021

(51) Int. Cl. H04N 1/00; E05D 11/00

(52) U.S. Cl. CPC H04N 1/00554; E05D 11/00; E05Y 2900/606; E05Y 2201/224; E05Y 2800/406

(57) ABSTRACT

According to examples, an apparatus may include a body on which a scanning surface is supported, a lid to cover the scanning surface, and a hinge to rotatably couple the lid to the body. In some examples, the apparatus may include a hinge support assembly disposed on the body. The hinge support assembly may include a first engagement member that may extend from the lid and a second engagement member that may extend from the body. The first engagement member may engage the second engagement member when the lid is in a certain position relative to the scanning surface. The first engagement member may contact the second engagement member to restrict a lateral movement of the lid relative to the hinge.

### BACKGROUND

Scanners may have lids that cover a scanning surface. The lids may be attached to the scanners via hinges. In some examples, when the lids are pressed down on media having relatively large thicknesses, lateral forces may be exerted on the hinges.

### BRIEF DESCRIPTION OF THE DRAWINGS

Features of the present disclosure are illustrated by way of example and not limited in the following figure(s), in which like numerals indicate like elements, in which:

FIG. 1A depicts a cross-sectional side view of an example apparatus that may include a body on which a scanning surface may be supported, a lid to cover the scanning surface, a hinge to couple the lid to the body, and a hinge support assembly disposed on the body, in which the hinge support assembly may include a first engagement member and a second engagement member;

FIG. 1B depicts a cross-sectional side view of the example apparatus depicted in FIG. 1A, in which the first engagement member is engaged with the second engagement member to prevent lateral movement of the lid relative to the hinge;

FIG. 2A depicts a perspective view of the first engagement member of the hinge support assembly depicted in FIGS. 1A and 1B;

FIG. 2B depicts a perspective view of the second engagement member of the hinge support assembly depicted in FIGS. 1A and 1B;

FIGS. 3A to 3D depict cross-sectional side views of an example hinge assembly that may include a recess disposed on a surface of the lid and a protrusion that may extend from the body, in which the hinge assembly is respectively depicted in an open position, a lid open position, a disengaged position, and an engaged position; and

FIG. 4 depicts a perspective view of an example scanner that may include a bezel on which a scanning surface may be supported, a lid, a hinge to couple the lid, a hook disposed adjacent to the hinge, and a protrusion to engage the hook to prevent lateral movement of the lid relative to the hinge.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Scanners may have lids, such as lids for automatic document feeders (ADFs), that cover scanning surfaces. A lid may be rotatably coupled to the scanner, for instance, by a hinge mounted between the lid and a scanner bezel that may surround the scanning surface. In many of these instances, the lid and scanner bezel interface hinge designs may not support book scanning. For instance, during scanning, when the lid is closed over a document having a relatively large thickness, such as books, the lid may dislodge or be damaged under relatively low pressing forces, which may result in lateral forces to be exerted on the hinge.

Disclosed herein are apparatuses having an interlock hinge design that may provide structural support to the hinge, which may increase the amount of pressing forces that the lid may withstand. By way of particular example and for purposes of illustration, a hinge support assembly as described in the present disclosure may increase the allowable pressing force at the lid to be about 60N, compared to less than about 20N without the added support. The apparatuses disclosed herein may result in improved strength of the lid hinge, which in turn may reduce potential costs associated with repair/replacement of damaged scanner lids and/or hinges due to book scanning.

In some examples, an apparatus may include a body disposed around a scanning surface, a lid disposed to cover the scanning surface, a hinge disposed between the cover and the body to rotatably couple the cover to the body, and a hinge support assembly to provide structural support to the hinge. The hinge support assembly may include a first engagement member that extends from the cover and a second engagement member that extends from the body to engage with the first engagement member. The first engagement member may engage the second engagement member based on a position of the cover relative to the scanning surface. In some examples, the first engagement member may contact the second engagement member to restrict a lateral movement of the lid relative to the hinge.

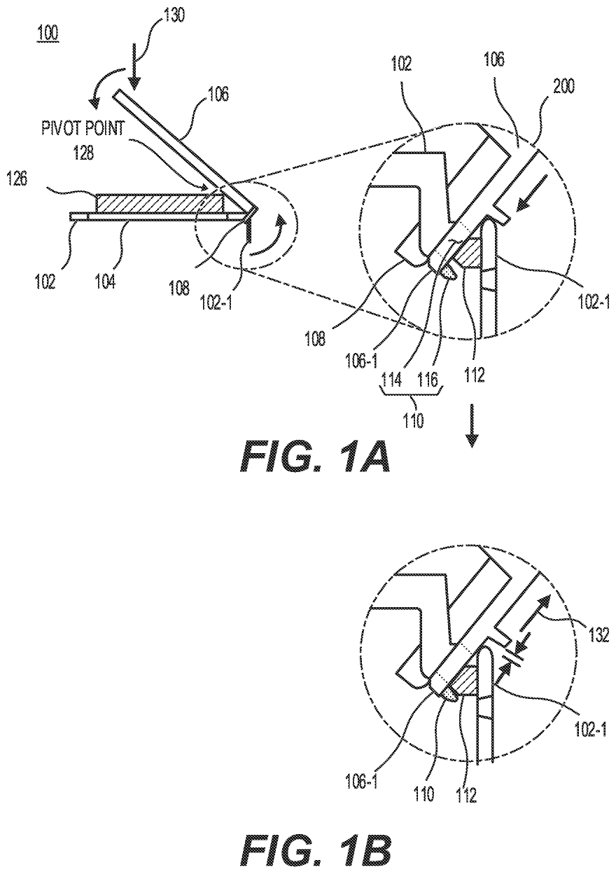

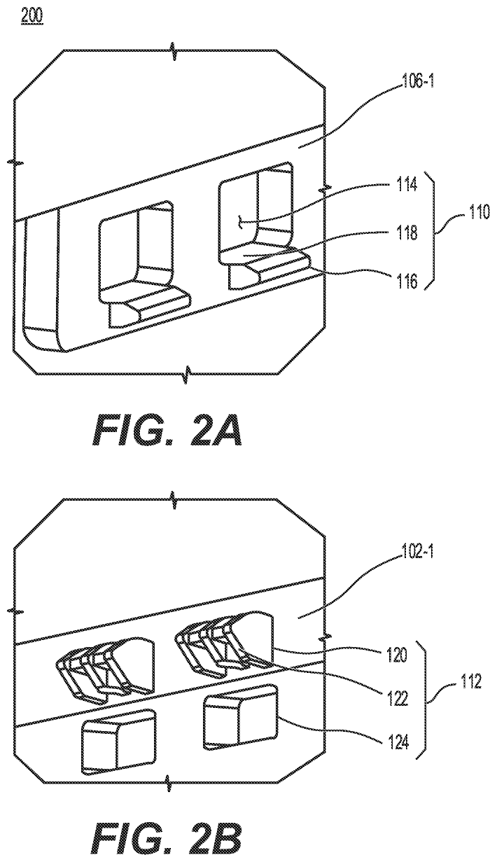

Reference is first made to FIGS. 1A, 1B, 2A, and 2B. FIG. 1A depicts a cross-sectional side view of an example apparatus 100 that may include a body 102 on which a scanning surface 104 may be supported, a lid 106 to cover the scanning surface 104, a hinge 108 to couple the lid 106 to the body 102, and a hinge support assembly 200 disposed on the body 102, in which the hinge support assembly 200 may include a first engagement member 110 and a second engagement member 112. FIG. 1B depicts a cross-sectional side view of the example apparatus 100 depicted in FIG. 1A, in which the first engagement member 110 is engaged with the second engagement member 112 to restrict lateral movement of the lid 106 relative to the hinge 108. FIG. 2A depicts a perspective view of the first engagement member 110 in the hinge support assembly 200 depicted in FIGS. 1A and 1B. FIG. 2B depicts a perspective view of the second engagement member 112 in the hinge support assembly 200 depicted in FIGS. 1A and 1B. It should be understood that the apparatus 100 depicted in FIGS. 1A and 1B and the hinge support assembly 200 depicted in FIGS. 2A and 2B may include additional features and that some of the features described herein may be removed and/or modified without departing from the scope of the apparatus 100 and the hinge support assembly 200.

In some examples, the apparatus 100 may include a body 102 on which a scanning surface 104 may be supported. The body 102 may be a bezel disposed around the scanning surface 104. The apparatus 100 may include a lid 106 to cover the scanning surface 104. A hinge 108, which may rotatably couple the lid 106 to the body 102, may be disposed at a distal end of the lid 106, for instance, at a side of the lid 106 near the back of the apparatus 100. The hinge 108 may be one of various types of hinges that may allow rotational movement of the lid 106 relative to the body 102.

In some examples, a hinge support assembly 200 may be disposed on the body 102. The hinge support assembly 200 may be positioned at the same side of the apparatus 100 as the hinge 108 to provide structural support to the hinge 108. In some examples, the hinge support assembly 200 may be positioned near a rotational axis of the hinge 108. The hinge support assembly 200 may include a first engagement member 110, which may extend from the lid 106, and a second engagement member 112, which may extend from the body 102.

In some examples, the lid 106 may have a section that extends down a side of the body 102. For instance, the lid 106 may include a section 106-1 that may extend down at the back of the apparatus 100. In some examples, the first engagement member 110 may be formed on the section 106-1 of the lid 106 that extends downward, as depicted in FIG. 1A.

In some examples, the first engagement member 110 may include a portion of the section 106-1 of the lid 106 that extends downward and a recess 114 formed on a surface of the section 106-1. When the lid 106 is in a closed position, the lid 106 may extend in a first direction, parallel with the scanning surface 104, and the first engagement member 110 may extend from the lid 106 in a second direction at a predetermined angle relative to the first direction, for instance, extend down from the lid 106 in a direction perpendicular to the scanning surface 104.

The recess 114 may face in the first direction toward the second engagement member 112 when the lid 106 is positioned in a closed position. In some examples, the recess 114 may be an opening formed through the section 106-1 of the lid 106, a cavity or a depression formed on a surface of the section 106-1, a hook or a catch having predetermined shape, and/or the like. For instance, the recess 114 may be an ‘L’ shaped section formed on the section 106-1.

In some examples, the first engagement member 110 may include a protrusion 116, which may extend from the section 106-1 of the lid 106 toward the second engagement member 112. The first engagement member 110 may include a first surface 118, which may be a contact surface to engage the second engagement member 112. In this regard, the first surface 118 may include a surface inside the recess 114 and/or a surface on the protrusion 116.

In some examples, the second engagement member 112 may include a portion of the section 102-1 of the body 102 that may extend down relative to the scanning surface 104 and a protrusion 120 that may extend from the section 102-1 of the body 102. In some examples, the second engagement member 112 may extend from the body 102 in the first direction, for instance, in an inward direction, toward the scanning surface 104. The second engagement member 112 may include a second surface 122, which may be a contact surface to engage with the first engagement member 110. In some examples, the second engagement member 112 may include a recess 124 formed on the section 102-1 of the body 102, which may accommodate the protrusion 116 of the first engagement member 110 when the lid 106 is in a closed position.

The first engagement member 110 may engage the second engagement member 112 based on movement of the lid 106 relative to the scanning surface 104. The first engagement member 110 may rotate relative to the second engagement member 112 based on movement of the lid 106, and when the lid 106 is positioned between a predetermined angle relative to the scanning direction and the closed position, the first engagement member 110 may be engaged with the second engagement member 112. In some examples, the first engagement member 110 may be engaged with the second engagement member 112 based on relative positions with each other, without physically touching each other.

In this regard, when the lid 106 is closed by more than the predetermined angle, the first engagement member 110 may be moved such that the first surface 118 of the first engagement member 110 is positioned to face the second surface 122 of the second engagement member 112. In some examples, the first engagement member 110 may be in an engaged position with the second engagement member 112 when the second engagement member 112 is positioned inside the recess 114 formed in the first engagement member 110.

When the lid 106 is positioned between the predetermined angle relative to the scanning surface 104 and an open position, the second engagement member 112 may disengage from the first engagement member 110. In these instances, the first surface 118 may be moved away from the second surface 122 and/or the second engagement member 112 may be positioned outside of the recess 114 formed in the first engagement member 110.

In some examples, in the engaged position as depicted FIG. 1A, the hinge support assembly 200 may prevent a lateral movement of the lid 106 relative to the hinge 108. By way of particular example and for purposes of illustration, a media 126 having a relatively large thickness may be placed on the scanning surface 104. The lid 106 may contact the media at a pivot point 128, and a downward force 130 at the lid 106 may cause a lateral force to be exerted on the hinge 108 in a lateral direction, as shown by arrow 132 in FIG. 1B. In some examples, the lid 106 may laterally move relative to the hinge 108 in the direction of arrow 132 due to the downward force 130. In this regard, a lateral movement of the lid 106 at the hinge 108 greater than a predetermined amount may cause damage to the hinge 108, the lid 106, and/or the body 102. As such, when the lateral force is exerted on the hinge 108, the first surface 118 of the first engagement member 110 may move laterally to contact the second surface 122 as the lid moves laterally with respect to the hinge 108, in order to restrict lateral movement of the lid 106 relative to the hinge 108.

In this regard, the first engagement member 110 may be engaged with the second engagement member 112 through a range of angles of the lid 106 to accommodate various thicknesses of the media 126. The range of angles at which the first engagement member 110 and the second engagement member 112 may be engaged with each other may be based on various shapes and angles of the first surface 118 and/or the second surface 122. The shapes of the first engagement member 110 and/or the second engagement member 112, and/or the angles of the first surface 118 and the second surface 122 may be user-defined, or may be based on testing, modeling, simulations, and/or the like.

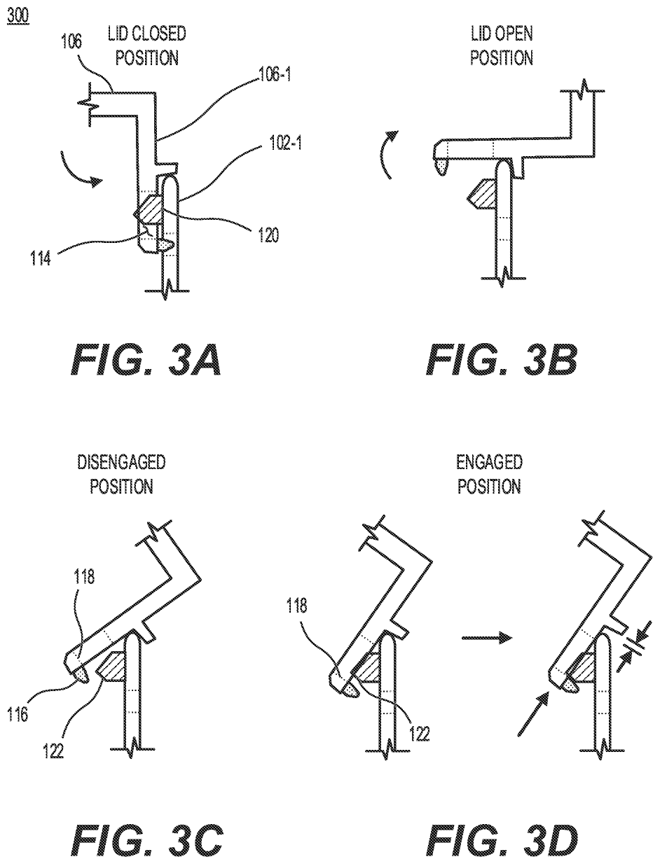

Reference is now made to FIGS. 3A to 3D. FIGS. 3A to 3D depict cross-sectional side views of an example hinge assembly 300 that may include a recess disposed on a surface of the lid 106 and a protrusion that may extend from the body 102, in which the hinge assembly 300 is respectively depicted in an lid closed position, a lid open position, a disengaged position, and an engaged position. The descriptions of the example hinge assembly 300 is made with reference to the features depicted in FIGS. 1A, 1B, 2A, and 2B for purposes of illustration. It should be understood that the hinge assembly 300 may include additional features and that some of the features described herein may be removed and/or modified without departing from the scope of the hinge assembly 300.

The hinge assembly 300 may include a hinge 108 to rotatably couple a lid 106 for a scanner to a body 102 of the scanner. A recess, such as the recess 114 depicted in FIG. 2A, may be disposed on a surface of the lid 106 adjacent to the hinge 108. The surface on which the recess 114 is formed may be on the section 106-1 of the lid 106. The recess 114 may have a first contact surface, such as the first surface 118 depicted in FIG. 2A. In this regard, the first contact surface may be a surface inside the recess 114. Alternatively or additionally, a protrusion 116 may be formed to extend from the recess 114, and in these instances, the first contact surface may include a surface on the protrusion 116 and/or the surface inside the recess 114.

A protrusion 120 may extend from the body 102 and may have a second contact surface, such as the second surface 122 depicted in FIG. 2B. In response to a movement of the lid 106 relative to the body 102, the recess 114 may engage the protrusion 120 to position the first contact surface relative to the second contact surface.

When the lid 106 is in a closed position, as depicted in FIG. 3A, the recess 114 may be engaged with the protrusion 120 to position the protrusion 120 inside the recess 114. In the closed position, the first contact surface may be positioned to face the second contact surface at a predetermined distance from the second contact surface. For instance, in the closed position where relatively thick media 126 is not being scanned, the first contact surface may not contact the second contact surface since, in these instances, the lid 106 may not be laterally displaced relative to the hinge 108.

When the lid 106 is positioned in an open position, as depicted in FIG. 3B, or when the lid 106 is positioned in a disengaged position, as depicted in FIG. 3C, which may be between a predetermined angle relative to the body 102 and the open position, the protrusion 120 may be disengaged from the recess 114. In some examples, in the disengaged position, the protrusion 120 may be positioned outside of the recess 114 and/or the first contact surface may be positioned away from the second contact surface.

When the lid 106 is positioned in an engaged position, as depicted in FIG. 3D, between a predetermined angle relative to the body 102 and a closed position, the protrusion 120 may be positioned inside the recess 114. In some examples, the protrusion 120 and the recess 114 may be engaged with each other by positioning the first contact surface to face the second contact surface. While in the engaged position, the first contact surface may contact the second contact surface in response to a lateral movement of the lid 106 relative to the hinge 108. In this regard, a lateral movement of the lid 106 relative to the hinge 108 beyond a predetermined threshold amount may be restricted the first and second contact surfaces.

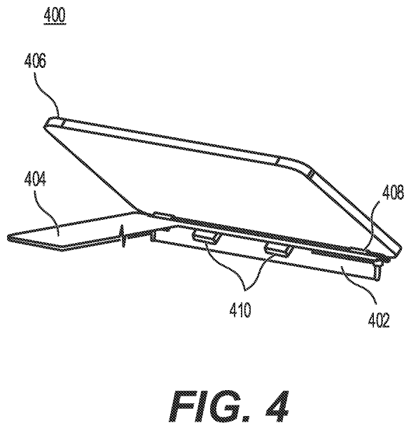

Reference is now made to FIG. 4. FIG. 4 depicts a perspective view of an example scanner 400 that may include a bezel 402 on which a scanning surface 404 may be supported, a lid 406, a hinge 408 to couple the lid 406, a hook 410 disposed adjacent to the hinge 408, and a protrusion to engage the hook 410 to prevent lateral movement of the lid 406 relative to the hinge 408. The descriptions of the example scanner 400 is made with reference to the features depicted in FIGS. 1A to 1B, 2A to 2B, and 3A to 3D for purposes of illustration. It should be understood that the scanner 400 may include additional features and that some of the features described herein may be removed and/or modified without departing from the scope of the scanner 400.

The bezel 402 may be disposed around the scanning surface 404. The bezel 402 may be the same as the section 102-1 of the body 102 and the scanning surface 404 may be the same as the scanning surface 104, depicted in FIG. 1A. The lid 406, which may be the same as the lid 106 depicted in FIG. 1A, may cover the scanning surface 404. The hinge 408 may be disposed between the lid 406 and the bezel 402 to rotatably couple the lid 406 to the bezel 402.

A hook 410 and a protrusion to engage the hook 410, such as the protrusion 120 depicted in FIG. 2B, may be disposed on a surface of the lid 406 adjacent to the hinge 408. In some examples, the hook 410 may be a combination of the recess 114 and the protrusion 116 depicted in FIG. 2A. In some examples, the protrusion 116 may have a predetermined shape to catch or hook the protrusion 120. The hook 410 may be disposed along a rotational axis of the hinge 408 to protect the hinge 408 from lateral forces applied to the hinge 408.

The protrusion 120 may extend from the bezel 402 and may engage the hook 410 in response to movement of the lid 406 relative to the scanning surface 404. In this regard, the hook 410 may engage with the protrusion 120 to prevent lateral movement of the lid 406 relative to the hinge 408, for instance, due to the lid 406 being pressed down on a media 126 having a relatively large thickness.

In some examples, when the lid 406 is positioned between a predetermined angle relative to the scanning surface 404 and a closed position, the protrusion 120 may be positioned inside the hook 410 disposed on the surface of the lid 406. When the lid 406 is positioned between the predetermined angle relative to the scanning surface 404 and an open position, the protrusion 120 may be positioned outside of the hook 410 disposed on the surface of the lid 406.

In some examples, the hook 410 may have a first surface, such as the first surface 118 depicted in FIG. 2A, and the protrusion 120 may have a second surface 122 that faces the first surface 118 when the hook 410 and the protrusion 120 are engaged with each other. In some examples, the first surface 118 may contact the second surface 122 in response to the lateral movement of the lid 406 relative to the hinge 408.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a body on which a scanning surface is supported;
a lid to cover the scanning surface;
a hinge to rotatably couple the lid to the body; and
a hinge support assembly disposed on the body, the hinge support assembly comprising:
a first engagement member that extends from the lid; and
a second engagement member that extends from the body, the first engagement member to engage the second engagement member when the lid is in a certain position relative to the scanning surface, the first engagement member to contact the second engagement member to restrict a lateral movement of the lid relative to the hinge.

2. The apparatus of claim 1, wherein, when the lid is in a closed position, the lid extends in a first direction and the first engagement member extends from the lid in a second direction at a predetermined angle relative to the first direction.

3. The apparatus of claim 2, wherein the second engagement member extends from the body in the first direction toward the scanning surface.

4. The apparatus of claim 3, wherein the first engagement member includes a recess formed on a surface of the lid, the recess to face in the first direction toward the second engagement member when the lid is positioned in the closed position.

5. The apparatus of claim 4, wherein, when the lid is positioned between a predetermined angle relative to the scanning surface and the closed position, the second engagement member is positioned inside the recess formed in the first engagement member.

6. The apparatus of claim 4, wherein, when the lid is positioned between a predetermined angle relative to the scanning surface and an open position, the second engagement member is positioned outside of the recess formed in the first engagement member.

7. The apparatus of claim 1, wherein the first engagement member is to rotate relative to the second engagement member based on movement of the lid, and wherein
the first engagement member is to engage the second engagement member when the lid is positioned between a predetermined angle and a closed position; and
the second engagement member is to disengage from the first engagement member when the lid is positioned between the predetermined angle and an open position.

8. The apparatus of claim 1, wherein the first engagement member has a first surface and the second engagement member has a second surface that faces the first surface when the first engagement member and the second engagement member are engaged with each other, wherein the first surface is to contact the second surface when the lid moves laterally with respect to the hinge.

9. A hinge assembly comprising:
a hinge to rotatably couple a lid for a scanner to a body of the scanner;
a recess disposed on a surface of the lid adjacent to the hinge, the recess having a first contact surface; and
a protrusion that extends from the body, the protrusion having a second contact surface,
wherein, in response to a movement of the lid relative to the body, the recess is to engage the protrusion to position the first contact surface relative to the second contact surface, the first contact surface to contact the second contact surface in response to a lateral movement of the lid relative to the hinge.

10. The hinge assembly of claim 9, wherein, when the lid is positioned between a predetermined angle relative to the body and a closed position, the protrusion is positioned inside the recess.

11. The hinge assembly of claim 9, wherein, when the lid is positioned between a predetermined angle relative to the body and an open position, the protrusion is positioned outside of the recess.

12. The hinge assembly of claim 9, wherein, when the lid is in a closed position, the recess is engaged with the protrusion to position the protrusion inside the recess, and the first contact surface is positioned to face the second contact surface at a predetermined distance from the second contact surface.

13. A scanner comprising:
a bezel disposed around a scanning surface;
a lid to cover the scanning surface;
a hinge disposed between the lid and the bezel to rotatably couple the lid to the bezel;
a hook disposed on a surface of the lid adjacent to the hinge; and
a protrusion that extends from the bezel, the protrusion to engage the hook in response to movement of the lid relative to the scanning surface, the hook to engage with the protrusion to restrict lateral movement of the lid relative to the hinge.

14. The scanner of claim 13, wherein
when the lid is positioned between a predetermined angle relative to the scanning surface and a closed position, the protrusion is positioned inside the hook disposed on the surface of the lid, and
when the lid is positioned between the predetermined angle relative to the scanning surface and an open position, the protrusion is positioned outside of the hook disposed on the surface of the lid.

15. The scanner of claim 13, wherein the hook has a first surface and the protrusion has a second surface that faces the first surface when the hook and the protrusion are engaged with each other, wherein the first surface is to contact the second surface in response to the lateral movement of the lid relative to the hinge.
